(19) United States
(12) Patent Application Publication
(10) Pub. No.: US 2026/0124845 A1
(43) Pub. Date: May 7, 2026

(54) PRINTING DEVICE

(71) Applicant: SEIKO EPSON CORPORATION, Tokyo (JP)

(72) Inventor: Hiroyuki NAKAYAMA, SHIOJIRI-SHI (JP)

(21) Appl. No.: 19/380,502

(22) Filed: Nov. 5, 2025

(30) Foreign Application Priority Data
Nov. 6, 2024 (JP) 2024-194209

(51) Int. Cl. B41J 29/13; B41J 29/02

(52) U.S. Cl. CPC B41J 29/13; B41J 29/02

(57) ABSTRACT

A printing device 1 includes a printing section 5 that prints on a medium; a housing 100 that accommodates the printing section 5 and includes an opening 400 configured to open a part of the housing 100; and an opening and closing cover 200 that covers the opening 400 and that opens and closes in a vertical direction, wherein the opening and closing cover 200 includes a side wall extending in the vertical direction in a closed state and at least one of a lower end section 202B of the side wall and an edge 110 of the opening 400 faces the lower end section 202B in the closed state is configured to deform in the vertical direction.

The present application is based on, and claims priority from JP Application Serial Number 2024-194209, filed November 6, 2024, the disclosure of which is hereby incorporated by reference herein in its entirety.

### BACKGROUND

### 1. Technical Field

The present disclosure relates to a printing device.

### 2. Related Art

In the related art, various printing devices have been used. Among these, there is a printing device including a configuration in which an opening and closing cover that is opened and closed in a vertical direction with respect to a housing is provided. For example, JP-A-2020-104426 discloses a liquid ejection device including a maintenance cover that can be opened and closed in the vertical direction.

In the related art printing device including an opening and closing cover that can be opened and closed in the vertical direction, when the opening and closing cover is closed, the opening and closing cover is closed vigorously by gravity, and thus there is a possibility that the opening and closing cover and an opening of a housing may collide vigorously or a user's finger or the like may be caught between the opening and closing cover and the opening of the housing. That is, opening and closing the opening and closing cover requires a user to pay attention to it, and opening and closing the opening and closing cover can be a burden for the user. On the other hand, if a damper mechanism or a spring mechanism having a large spring force is provided so that the opening and closing cover is slowly closed when the opening and closing cover is closed, the cost may increase or a space inside the opening and closing cover may be reduced.

### SUMMARY

A printing device of the present disclosure for overcoming the above-described problem includes a printing section that prints on a medium; a housing that accommodates the printing section and that includes an opening configured to open a part of the housing; and an opening and closing cover that covers the opening and that opens and closes in a vertical direction, wherein the opening and closing cover includes a side wall extending in the vertical direction in a closed state and at least one of a lower end section of the side wall and an edge of the opening that faces the lower end section in the closed state is configured to deform in the vertical direction.

### BRIEF DESCRIPTION OF THE DRAWINGS

FIG. 1 is a schematic perspective view of a printing device according to a first embodiment of the present disclosure.

FIG. 2 is a perspective view showing a periphery of an opening and closing cover of the printing device of FIG. 1, and is a diagram showing a state where the opening and closing cover is fully opened.

FIG. 3 is a perspective view showing a periphery of the opening and closing cover of the printing device of FIG. 1 as viewed from an angle different from that of FIG. 2, and is a diagram showing a state in which the opening and closing cover is moved in a closing direction from a state shown in FIG. 2.

FIG. 4 is a perspective view showing a periphery of the opening and closing cover of the printing device of FIG. 1, and is a diagram showing a state in which the opening and closing cover is moved in the closing direction from a state shown in FIG. 3.

FIG. 5 is a perspective view showing a periphery of the opening and closing cover of the printing device of FIG. 1, and is a diagram showing a state in which the opening and closing cover is closed by moving the opening and closing cover in the closing direction from the state shown in FIG. 3, and a user's finger is caught between the opening and closing cover and an opening of a housing.

FIG. 6 is a perspective view showing a periphery of the opening and closing cover of a printing device according to a second embodiment of the present disclosure, and is a diagram showing a state in which a user's finger is caught between the opening and closing cover and the opening of the housing.

FIG. 7 is a perspective view showing a periphery of the opening and closing cover of a printing device according to a third embodiment of the present disclosure.

FIG. 8 is a perspective view showing a periphery of the opening and closing cover of a printing device according to a fourth embodiment of the present disclosure, and is a diagram showing a state in which a user's finger is caught between the opening and closing cover and the opening of the housing.

FIG. 9 is a side view of a printing device according to a reference example.

### DESCRIPTION OF EMBODIMENTS

First, the present disclosure will be schematically described.

A printing device according to a first aspect of the present disclosure for overcoming the above-described problem includes a printing section that prints on a medium; a housing that accommodates the printing section and that includes an opening configured to open a part of the housing; and an opening and closing cover that covers the opening and that opens and closes in a vertical direction, wherein the opening and closing cover includes a side wall extending in the vertical direction in a closed state and at least one of a lower end section of the side wall and an edge of the opening that faces the lower end section in the closed state is configured to deform in the vertical direction.

According to the present aspect, at least one of the lower end section of the side wall of the opening and closing cover that opens and closes in the vertical direction and the edge of the opening of the housing that faces the lower end section in the closed state is configured to deform in the vertical direction. Since at least one of the lower end section of the side wall and the edge of the opening of the housing is deformed in the vertical direction, it is possible to reduce a collision force between the opening and closing cover and the opening of the housing when the opening and closing cover is closed without providing a damper mechanism or the like, and it is possible to alleviate the impact even when a user pinches a finger or the like between the opening and closing cover and the opening of the housing, for example. That is, the burden on a user associated with opening and closing the opening and closing cover can be reduced with a simple configuration.

A printing device according to a second aspect of the present disclosure is an aspect according to the first aspect, and the side wall includes an upper wall and a lower wall arranged at a position lower than the upper wall in the vertical direction and the lower wall includes the lower end section and is configured to deform with respect to the upper wall.

According to the present aspect, the side wall of the opening and closing cover includes the upper wall and the lower wall arranged at a position lower than the upper wall in the vertical direction, and the lower wall includes the lower end section and is configured to deform with respect to the upper wall. With this configuration, it is possible to effectively reduce a collision force between the opening and closing cover and the opening of the housing when the opening and closing cover is closed.

A printing device according to a third aspect of the present disclosure is an aspect according to the second aspect, and the lower wall is configured to be displaced in a direction toward the upper wall.

According to the present aspect, the lower wall is configured to be displaced in a direction toward the upper wall. With this configuration, a collision force between the opening and closing cover and the opening of the housing when the opening and closing cover is closed can be reduced particularly effectively.

A printing device according to a fourth aspect of the present disclosure is an aspect according to the third aspect, and the lower wall is supported by the upper wall while being biased in a direction away from the upper wall.

According to the present aspect, the lower wall of the side wall of the opening and closing cover is supported by the upper wall while being biased in a direction away from the upper wall. With this configuration, even when a shape of the opening and closing cover is deformed as the opening and closing cover is opened and closed, the shape of the opening and closing cover can be easily restored.

A printing device according to a fifth aspect of the present disclosure is an aspect according to any one of the second to fourth aspects, and the lower wall has lower rigidity than the upper wall.

According to the present aspect, the lower wall of the side wall of the opening and closing cover has lower rigidity than the upper wall. With this configuration, even when rigidity of the upper wall is increased, the burden on a user associated with opening and closing of the opening and closing cover can be reduced, and rigidity of the entire opening and closing cover is increased, so that a gap with respect to the opening can be reduced, and thus a function of the opening and closing cover such as suppression of entry of foreign matter can be suitably maintained.

A printing device according to a sixth aspect of the present disclosure is an aspect according to any one of the second to fifth aspects, and the lower wall is formed of a material different from that of the upper wall.

According to the present aspect, the lower wall of the side wall of the opening and closing cover is formed of a material different from that of the upper wall. With this configuration, functions of the lower wall and the upper wall of the side wall of the opening and closing cover can be changed particularly easily, for example, the lower wall of the side wall of the opening and closing cover is configured to have lower rigidity than the upper wall.

A printing device according to a seventh aspect of the present disclosure is an aspect according to any one of the first to sixth aspects, and the lower end section is configured to deform in the vertical direction in a state where the opening and closing cover is closed, an edge of the opening includes a step section overlapping the lower end section in a direction intersecting the vertical direction in a state where the opening and closing cover is closed, and a length of the step section in the vertical direction is smaller than a deformation amount of the lower end section.

According to the present aspect, the lower end section of the side wall is configured to deform in the vertical direction, the edge of the opening of the housing includes the step section overlapping the lower end section in the direction intersecting the vertical direction in the state where the opening and closing cover is closed, and the length of the step section in the vertical direction is smaller than the deformation amount of the lower end section. With this configuration, it is possible to particularly alleviate the impact when a finger or the like is caught between the housing and the opening and closing cover.

A printing device according to an eighth aspect of the present disclosure is an aspect according to any one of the first to seventh aspects, and the lower end section is configured to deform in the vertical direction in a state where the opening and closing cover is closed, an edge of the opening includes a step section overlapping the lower end section in a direction intersecting the vertical direction in a state where the opening and closing cover is closed, and a length of the step section in the vertical direction is larger than a deformation amount of the lower end section.

According to the present aspect, the lower end section of the side wall is configured to deform in the vertical direction, the edge of the opening of the housing includes the step section overlapping the lower end section in the direction intersecting the vertical direction in the state where the opening and closing cover is closed, and the length of the step section in the vertical direction is larger than the deformation amount of the lower end section. With this configuration, a gap between the opening and closing cover and the opening can be reduced, and entry of foreign matter can be particularly suitably suppressed in the state where the opening and closing cover is closed.

A printing device according to a ninth aspect of the present disclosure is an aspect according to any one of the first to eighth aspects, and an edge of the opening includes a step section overlapping the lower end section in the vertical direction in a state where the opening and closing cover is closed and the step section is configured to be displaced in the vertical direction.

According to the present aspect, the edge of the opening includes the step section overlapping the lower end section in the vertical direction in the state where the opening and closing cover is closed, and the step section is configured to be displaced in the vertical direction. With this configuration, it is possible to particularly alleviate the impact when a finger or the like is caught between the housing and the opening and closing cover.

### FIRST EMBODIMENT

Hereinafter, a printing device 1A according to a first embodiment, which is an example of a printing device 1 according to the present disclosure, will be specifically described with reference to the drawings. Here, in each drawing, an X-axis direction in the drawing is horizontal direction and corresponds to a width direction of the printing device 1A, a Y-axis direction is horizontal direction and also corresponds to a front-rear direction of the printing device 1A and is perpendicular to the X-axis direction, and a Z-axis direction is a vertical direction.

In the following description, a direction indicated by an arrow is defined as a + direction, and a direction opposite to the direction indicated by the arrow is defined as a - direction. For example, a vertically upward direction is a +Z direction, a vertically downward direction is a -Z direction, a front direction of the printing device 1A is a +Y direction, and a rear direction of the printing device 1A is a -Y direction.

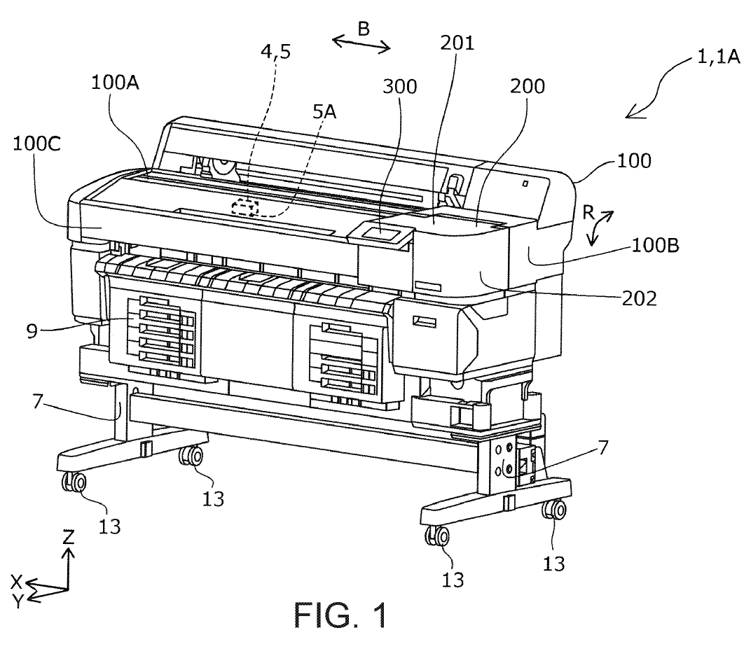

As shown in FIG. 1, the printing device 1A of the present embodiment includes a housing 100, and leg frames 7 are attached to portions in the vicinity of both ends of the housing 100 in the X-axis direction. Casters 13 are provided below the leg frames 7, and the printing device 1A can be easily moved by using the casters 13. The printing device 1A of the present embodiment includes a medium supply section (not shown) that holds medium wound in a roll shape inside the housing 100. The medium supply section supplies the medium to a position facing an ink ejection surface 5A of a head 5 as a printing section.

At a position where a wall 100A on a first direction side (+Z direction side) of the housing 100, a wall 100B on a second direction side (-X direction side) of the housing 100, and a wall 100C on a third direction side (+Y direction side) of the housing 100 are connected, an opening and closing cover 200 is provided that constitutes a part of the wall 100A and a part of the wall 100B. A configuration of the opening and closing cover 200 will be described later. An operation panel 300 is provided

in the vicinity of the opening and closing cover 200, and an operation surface of the operation panel 300 and the wall 100A are positioned at substantially the same height. The operation surface of the operation panel 300 is mainly directed in the +Z direction, but a direction of the operation surface may be changeable. The operation panel 300 of the present embodiment is configured by a display device including a touch panel. Therefore, the operation surface of the operation panel 300 is also a display surface, and various kinds of information are displayed thereon.

The printing device 1A of the present embodiment includes the head 5 as a printing section that is provided with a plurality of nozzles on the ink ejection surface 5A and ejects ink that is liquid from the nozzles to form an image, and a carriage 4 that is mounted with the head 5 and is capable of reciprocating in a width direction B. That is, the width direction B corresponds to a scanning direction of the carriage 4. Liquid supply paths (not shown) formed of tubes or the like are connected to the head 5, and ink is supplied to the head 5 from a plurality of ink cartridges (not shown) mounted on an ink cartridge mount section 9 via the liquid supply paths (not shown). In the printing device 1A of the present embodiment, a transport direction of a medium at a position facing the ink ejection surface 5A is the +Y direction, a movement direction of the head 5, that is, the width direction B that is a scanning direction of the carriage 4 is a direction along the X-axis direction, and an ejection direction of ink is a -Z direction.

With the above-described configuration, the head 5 can form an image by ejecting ink, which is liquid, from nozzles (not shown) onto a medium being transported while reciprocating in the width direction B, which is a direction intersecting the transport direction of the medium. The printing device 1A of the present embodiment can form a desired image on the medium by repeating transporting the medium by a predetermined transport amount and ejecting ink while moving the head 5 in the width direction B in a state in which the medium is stopped. However, the disclosure is not limited to such a configuration, and a configuration including a so-called line head in which nozzles that eject ink along the width direction B are arranged across the entire width of the medium may be adopted.

As described above, the printing device 1A of the present embodiment includes the head 5 that performs printing on the medium and the housing 100 that accommodates the head 5. As shown in FIG. 1, the housing 100 includes the opening and closing cover 200 that opens and closes a part of the housing 100. Hereinafter, a configuration of the opening and closing cover 200 and a configuration inside the opening and closing cover 200 will be described in detail.

As shown in FIGS. 1 to 5, the opening and closing cover 200 of the printing device 1A of the present embodiment includes a first wall 201 that is a part of the wall 100A on a first direction side (+Z direction side) of the housing 100, and a second wall 202 that serves as a side wall and that is a part of the wall 100B extending in a direction intersecting the first wall 201 of the housing 100 and that is provided on a second direction side (-X direction side) of the operation panel 300 in the width direction B. The second wall 202 includes an upper end section 202A and a lower end section 202B. The opening and closing cover 200 of the present embodiment is opened and closed by being pivoted in a pivot direction R by a pivot shaft 203 provided on the first wall 201 and extending in the width direction B.

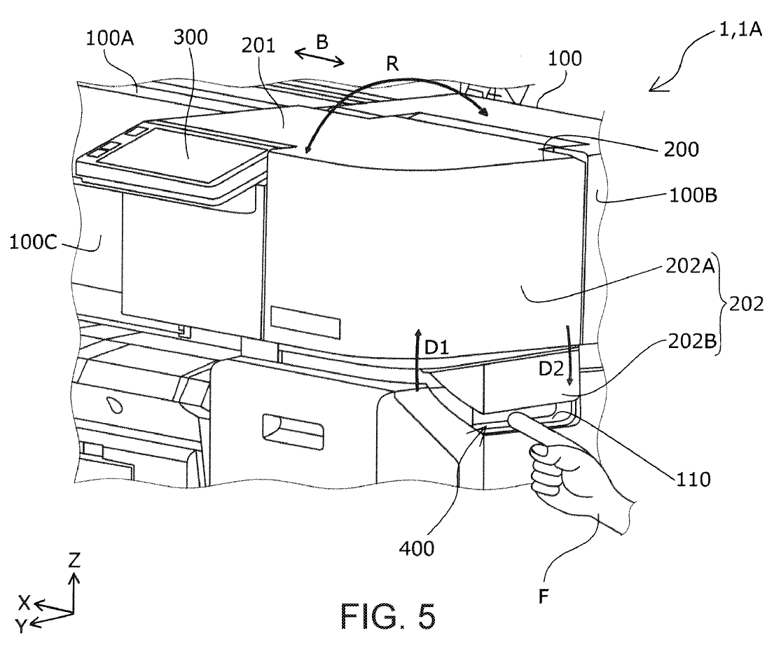

From another viewpoint, the opening and closing cover 200 of the present embodiment includes the second wall 202 as the side wall extending in the vertical direction in a closed state. In the following description, unless otherwise specified, the "vertical direction" means the vertical direction in a state where the opening and closing cover 200 is closed. The lower end section 202B of the second wall 202 is deformable in an upward direction D1 and a downward direction D2 in a state where the opening and closing cover 200 is closed as shown in FIG. 5. Hereinafter, the upward direction D1 and the downward direction D2 both mean an upward direction and a downward direction in a state where the opening and closing cover 200 is closed.

As in the printing device 1A of the present embodiment, it is desirable that at least one of the lower end section 202B of the second wall 202 of the opening and closing cover 200 that opens and closes in the vertical direction in the closed state and an edge 110 of the opening 400 of the housing 100 facing the lower end section 202B in the closed state is deformable in the vertical direction. As described above, at least one of the lower end section 202B of the second wall 202 and the edge 110 of the opening 400 of the housing 100 is deformed in the vertical direction, and thus, when the opening and closing cover 200 is closed, it is possible to reduce a collision force between the opening and closing cover 200 and the opening 400 of the housing 100 without providing a damper mechanism or the like, and for example, it is possible to alleviate the impact even when a user pinches a finger F or the like between the opening and closing cover 200 and the opening 400 of the housing 100. That is, the burden on a user associated with the opening and closing of the opening and closing cover 200 can be reduced with a simple configuration.

In the present embodiment, in a state where the opening and closing cover 200 is closed, the entire lower end section 202B of the second wall 202 as the side wall is deformable in the upward direction D1 and downward direction D2 with respect to the upper end section 202A. However, the present disclosure is not limited to such a configuration, and for example, at least a part of a lower end of the lower end section 202B as the side wall may be configured to be deformable in the upward direction D1 and downward direction D2. Further, in a state where the opening and closing cover 200 is closed, at least a part of the edge 110 of the opening 400 of the housing 100 may be deformable in the vertical direction, instead of the side wall of the opening and closing cover 200. Including other embodiments, the description focuses on the lower end section 202B being provided on a -X direction side of the second wall 202, but this is not limited to such a position and may be provided, for example, on a +Y direction side of the second wall 202.

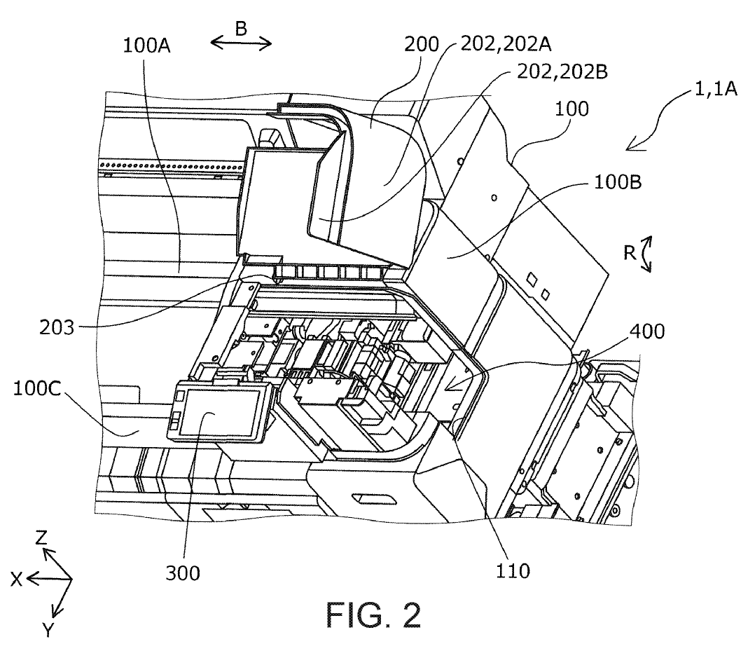

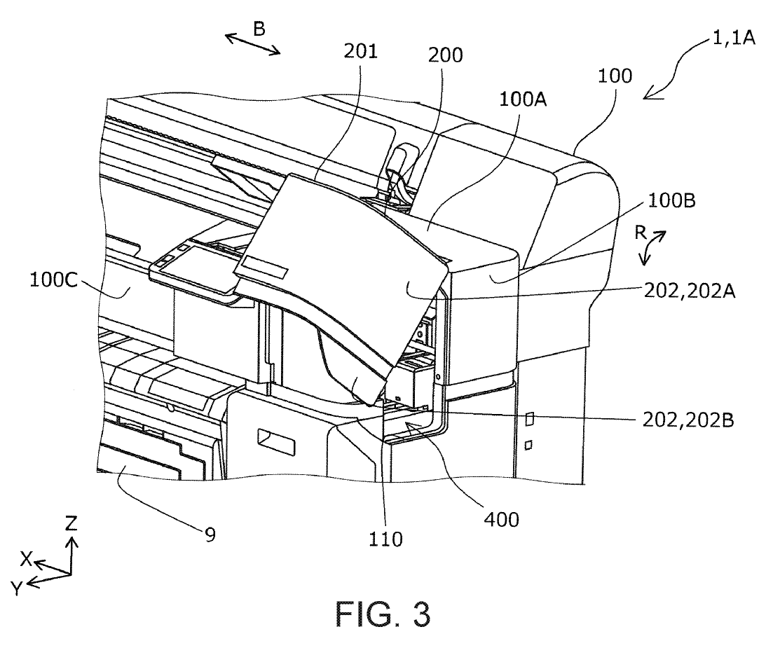

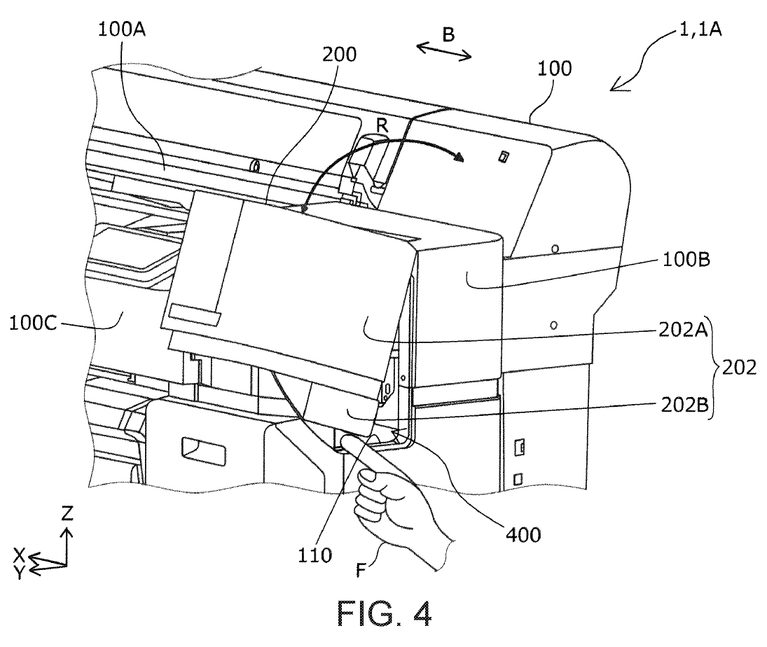

To describe the lower end section 202B in detail, when the printing device 1A of the present embodiment changes from the state of FIG. 2 to the state of FIG. 5 via the state of FIG. 3 and the state of FIG. 4, the lower end section 202B moves in the upward direction D1 with respect to the edge 110 of the opening 400 of the housing 100 when a user pinches the finger F between the opening and closing cover 200 and the opening 400 of the housing 100. Therefore, even when a user pinches the finger F between the opening and closing cover 200 and the opening 400 of the housing 100, the impact can be alleviated.

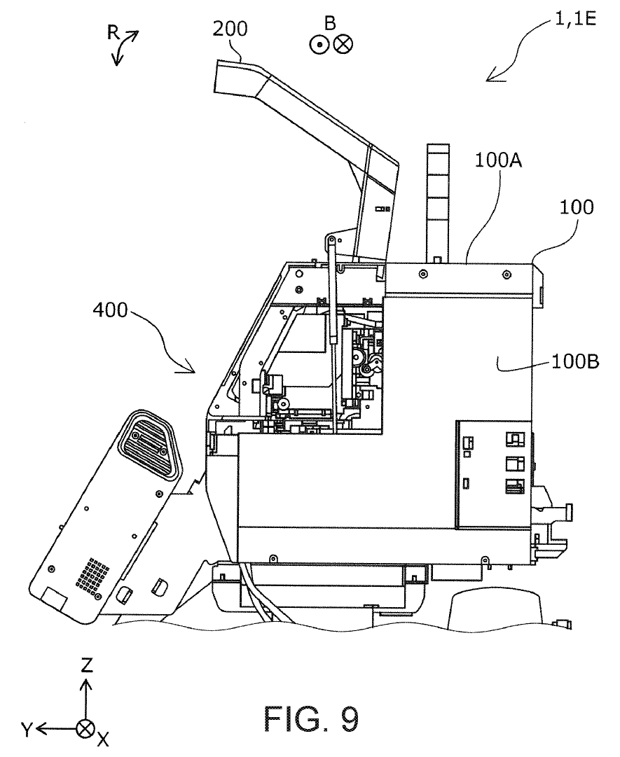

On the other hand, in a printing device 1E of a reference example shown in FIG. 9, the opening and closing cover 200 does not include a side wall that is deformable in the upward direction D1 and the downward direction D2. Therefore, when a user pinches the finger F between the opening and closing cover 200 and the opening 400 of the housing 100, the impact cannot be alleviated. Therefore, a user needs to pay attention so as not to pinch the finger F between the opening and closing cover 200 and the opening 400 of the housing 100, and the user must be careful when opening and closing opening and closing cover 200.

In the printing device 1A of the present embodiment, the second wall 202 as the side wall includes the upper end section 202A that is an upper wall, and the lower end section 202B that is a lower wall that is positioned lower than the upper end section 202A in the vertical direction. In other words, the lower wall of the side wall of the opening and closing cover 200 includes a lower end section 202B, and is configured to be deformable in the vertical direction with respect to the upper end section 202A that is the upper wall of the side wall of the opening and closing cover 200. With such a configuration, the printing device 1A of the present embodiment can effectively reduce a collision force between the opening and closing cover 200 and the opening 400 of the housing 100 when the opening and closing cover 200 is closed.

In still another expression, in the printing device 1A of the present embodiment, the lower end section 202B of the lower wall of the side wall of the opening and closing cover 200 is configured to be displaceable in the upward direction D1, which is a direction toward the upper end section 202A, which is the upper wall of the side wall of the opening and closing cover 200. With such a configuration, the printing device 1A of the present embodiment can particularly effectively reduce a collision force between the opening and closing cover 200 and the opening 400 of the housing 100 when the opening and closing cover 200 is closed.

In present specification, the term "displacement" of the lower end section 202B with respect to the upper end section 202A means that at least a part of the lower end section 202B moves with respect to the upper end section 202A. On the other hand, in the present specification, the lower end section 202B being "deformed" with respect to the upper end section 202A means that in addition to the lower end section 202B being "displaced" with respect to the upper end section 202A, it also includes the change in shape of at least a part of the lower end section 202B by bending or the like.

More specifically, in the printing device 1A of the present embodiment, the lower end section 202B is supported by the upper end section 202A in a state of being biased toward the downward direction D2 that is a direction away from the upper end section 202A by a biasing section (not shown). With such a configuration, the printing device 1A of the present embodiment can easily restore a shape of the opening and closing cover 200 even if the shape of the opening and closing cover 200 is deformed when the opening and closing cover 200 is opened or closed. This is because, when the opening and closing cover 200 is closed, a force applied from the outside to the upper end section 202A via the lower end section 202B can be reduced.

### SECOND EMBODIMENT

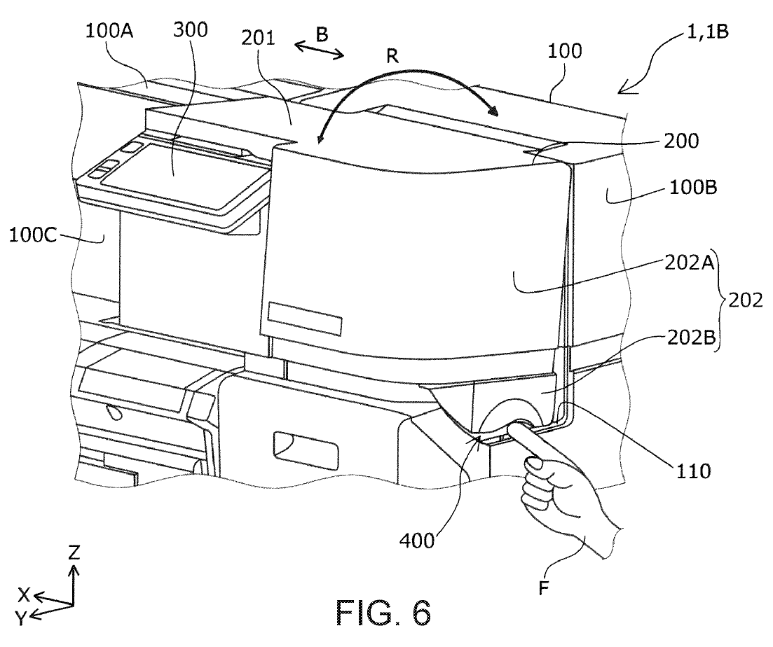

Next, a printing device 1B according to a second embodiment will be described with reference to FIG. 6. In FIG. 6, constituent members common to those of the first embodiment are denoted by the same reference symbols, and detailed description thereof will be omitted. FIG. 6 is a diagram corresponding to FIG. 5 in the printing device 1A of the first embodiment. Here, the printing device 1B of the present embodiment includes the same configuration as the printing device 1A of the first embodiment except for the portion of the opening and closing cover 200 described below. For this reason, the printing device 1B of the present embodiment has the same features as those of the printing device 1A of the first embodiment, except for the portion described below.

As described above, the opening and closing cover 200 of the printing device 1A of the first embodiment is configured so that the entire lower end section 202B, which is the lower wall of the side wall of the opening and closing cover 200, is capable of being displaced in the upward direction D1 with respect to the upper end section 202A, which is the upper wall of the side wall of the opening and closing cover 200. On the other hand, in the printing device 1B of the present embodiment, the entire lower end section 202B, which is the lower wall of the side wall of the opening and closing cover 200, is formed of a softer, more flexible material than the upper end section 202A. FIG. 6 shows a state in which the lower end section 202B is bent and deformed when a user pinches the finger F between the opening and closing cover 200 and the opening 400 of the housing 100.

From another viewpoint, the lower end section 202B of the printing device 1B of the present embodiment has lower rigidity than the upper end section 202A. With such a configuration, the printing device 1B of the present embodiment can reduce the burden on a user associated with the opening and closing of the opening and closing cover 200 even when rigidity of the upper end section 202A is increased. In addition, since rigidity of the entire opening and closing cover 200 is increased and a gap with respect to the opening 400 can be reduced, it is possible to suppress entry of foreign matter when the opening and closing cover 200 is closed, and it is possible to suitably maintain a function of the opening and closing cover 200. In the present embodiment, the lower end section 202B and the upper end section 202A are formed of separate constituent members, but the lower end section 202B and the upper end section 202A may be integrally formed, for example, by configuring a wall thickness of the lower end section 202B to be thinner than that of the upper end section 202A.

Here, in the printing device 1B of the present embodiment, the lower end section 202B is formed of a material different from that of the upper end section 202A. With this configuration, functions of the lower wall and the upper wall of the side wall of the opening and closing cover 200 can be changed particularly easily, for example, the lower wall of the side wall of the opening and closing cover 200 is configured to have lower rigidity than the upper wall.

By combining a configuration in which the lower end section 202B is displaced with respect to the upper end section 202A, which is the configuration of the first embodiment, and a configuration in which the lower end section 202B is formed of a soft flexible material, which is the configuration of the present embodiment, it is possible to particularly effectively reduce a collision force between the opening and closing cover 200 and the opening 400 of the housing 100 when the opening and closing cover 200 is closed.

### THIRD EMBODIMENT

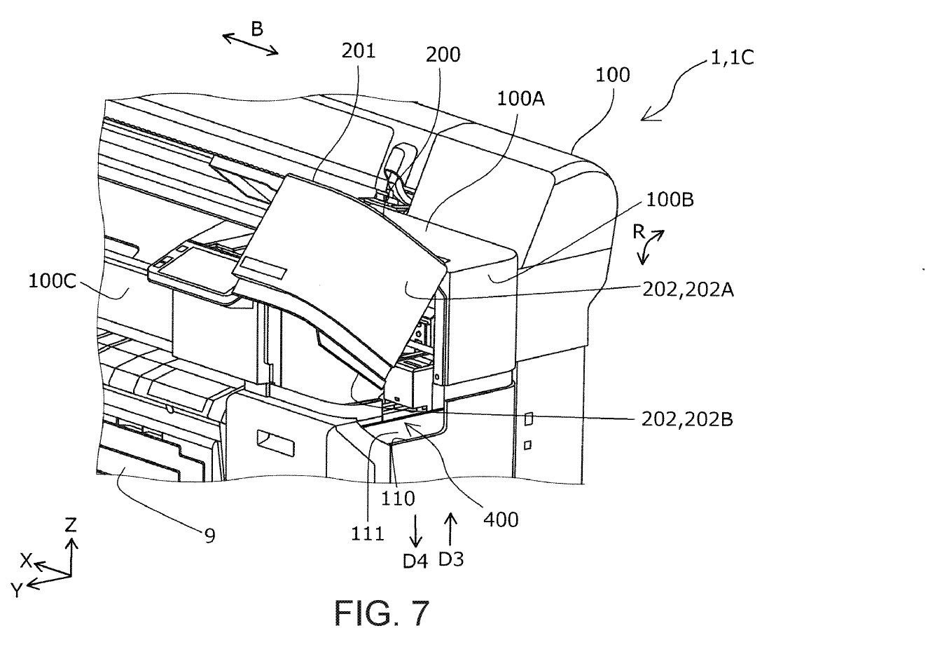

Next, a printing device 1C according to a third embodiment will be described with reference to FIG. 7. In FIG. 7, constituent members common to those of the first embodiment are denoted by the same reference symbols, and detailed description thereof will be omitted. FIG. 7 is a diagram corresponding to FIG. 3 in the printing device 1A of the first embodiment. Here, the printing device 1C of the present embodiment includes the same configuration as the printing device 1 of the first embodiment and the second embodiment except for the portion of the opening and closing cover 200 described below. For this reason, the printing device 1C of the present embodiment has the same features as those of the printing device 1 of the first embodiment and the second embodiment, except for the portion described below.

As described above, in the printing device 1 of the first embodiment and the second embodiment, the side wall of the opening and closing cover 200 is configured to be deformable. On the other hand, in the printing device 1C of the present embodiment, the lower end section 202B is formed of the same material as the upper end section 202A, and the lower end section 202B is fixed to the upper end section 202A. Instead of such a configuration, the printing device 1C of the present embodiment includes a configuration in which a step section 111, which is a part of the edge 110 of the opening 400 of the housing 100, is deformable in the upward direction D3 and downward direction D4. The step section 111 is configured to come into contact with the lower end section 202B and be pushed in the downward direction D4 when the opening and closing cover 200 is closed, and is configured to be capable of being pushed further downward in the downward direction D4 from that state.

From another viewpoint, in the printing device 1C of the present embodiment, the edge 110 of the opening 400 of the housing 100 includes the step section 111 overlapping the lower end section 202B in the vertical direction in a state where the opening and closing cover 200 is closed, and the step section 111 is capable of being displaced in the vertical direction. With such a configuration, the printing device 1C of the present embodiment can particularly reduce the impact when the user's finger F or the like is caught between the housing 100 and the opening and closing cover 200. For example, in a case where the opening and closing cover 200 is large and there is a possibility that the opening and closing cover 200 may be bent and deformed according to an opening and closing operation, there is a possibility that a portion deformed during the opening and closing operation collides with other constituent members, but by adopting a configuration in which the edge 110 of the opening 400 includes the step section 111 as in the printing device 1C of the present embodiment, it is possible to suppress interference with other member configurations.

### FOURTH EMBODIMENT

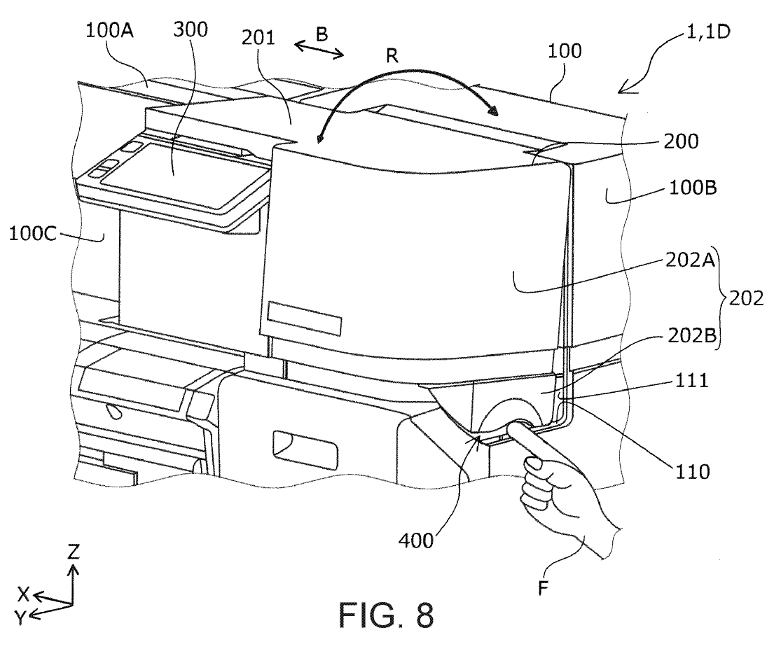

Next, a printing device 1D according to a fourth embodiment will be described with reference to FIG. 8. In FIG. 8, constituent members common to those of the first embodiment are denoted by the same reference symbols, and detailed description thereof will be omitted. FIG. 8 is a diagram corresponding to FIG. 5 in the printing device 1A of the first embodiment. Here, the printing device 1D of the present embodiment includes the same configuration as the printing device 1 of the first to third embodiments except for the portion of the opening and closing cover 200 described below. For this reason, the printing device 1D of the present embodiment has the same features as those of the printing device 1 of the first embodiment to third embodiment, except for the portion described below.

As described above, in the printing device 1B of the second embodiment, the lower end section 202B is formed of a flexible material having lower rigidity than the upper end section 202A. In the printing device 1D of the present embodiment, the lower end section 202B is also formed of a flexible material having lower rigidity than the upper end section 202A. The printing device 1C of the third embodiment includes the step section 111 overlapping the lower end section 202B in the vertical direction in a state where the opening and closing cover 200 is closed. On the other hand, the printing device 1D of the present embodiment includes the step section 111 overlapping the lower end section 202B in the X-axis direction, which is a direction intersecting the vertical direction, in a state where the opening and closing cover 200 is closed. However, unlike the step section 111 of the printing device 1C of the third embodiment, the step section 111 of the present embodiment does not displace in the vertical direction. That is, in the printing device 1D of the present embodiment, the lower end section 202B of the side wall is deformable in the vertical direction, and when the opening and closing cover 200 is closed, the step section 111, which is provided at a position that overlaps with the lower end section 202B in the X-axis direction but does not overlap in the vertical direction, does not displace in the vertical direction.

Here, a length of the step section 111 in the vertical direction is larger than a deformation amount of the lower end section 202B. With such a configuration, the printing device 1D of the present embodiment can reduce a gap between the opening and closing cover 200 and the opening 400, and can particularly suitably suppress entry of foreign matter in a state where the opening and closing cover 200 is closed. For example, it is possible to suppress a user's finger F from being inserted into the gap between the opening and closing cover 200 and the opening 400 and the user's finger F from coming into contact with the carriage 4 during execution of a printing operation in the printing device 1D.

However, a configuration is not limited to the configuration of the printing device 1D of the present embodiment, and a length of the step section 111 in the vertical direction may be smaller than a deformation amount of the lower end section 202B. By making a length of the step section 111 in the vertical direction smaller than a deformation amount of the lower end section 202B, it is possible to particularly alleviate the impact when a finger or the like is caught between the housing 100 and the opening and closing cover 200.

The present disclosure is not limited to the above-described embodiments, and can be realized by various configurations without departing from the scope of the disclosure.

In addition, the technical features in the embodiments corresponding to the technical features in the aspects described in the outline can be replaced or combined as appropriate in order to solve some or all of the above-described problems or in order to achieve some or all of the above-described effects. If the technical features are not described as essential in the present specification, the technical features can be appropriately omitted.

What is claimed is:

1. A printing device comprising:
a printing section that prints on a medium;
a housing that accommodates the printing section and that includes an opening configured to open a part of the housing; and
an opening and closing cover that covers the opening and that opens and closes in a vertical direction, wherein
the opening and closing cover includes a side wall extending in the vertical direction in a closed state and
at least one of a lower end section of the side wall and an edge of the opening that faces the lower end section in the closed state is configured to deform in the vertical direction.

2. The printing device according to claim 1, wherein
the side wall includes an upper wall and a lower wall arranged at a position lower than the upper wall in the vertical direction and
the lower wall includes the lower end section and is configured to deform with respect to the upper wall.

3. The printing device according to claim 2, wherein
the lower wall is configured to be displaced in a direction toward the upper wall.

4. The printing device according to claim 3, wherein
the lower wall is supported by the upper wall while being biased in a direction away from the upper wall.

5. The printing device according to claim 2, wherein
the lower wall has lower rigidity than the upper wall.

6. The printing device according to claim 5, wherein
the lower wall is formed of a material different from that of the upper wall.

7. The printing device according to claim 1, wherein
the lower end section is configured to deform in the vertical direction,
an edge of the opening includes a step section overlapping the lower end section in a direction intersecting the vertical direction in a state where the opening and closing cover is closed, and
a length of the step section in the vertical direction is smaller than a deformation amount of the lower end section.

8. The printing device according to claim 1, wherein
the lower end section is configured to deform in the vertical direction,
an edge of the opening includes a step section overlapping the lower end section in a direction intersecting the vertical direction in a state where the opening and closing cover is closed, and
a length of the step section in the vertical direction is larger than a deformation amount of the lower end section.

9. The printing device according to claim 1, wherein
an edge of the opening includes a step section overlapping the lower end section in the vertical direction in a state where the opening and closing cover is closed and
the step section is configured to be displaced in the vertical direction.
